(19) United States
(12) Patent Application Publication
(10) Pub. No.: US 2025/0094807 A1
(43) Pub. Date: Mar. 20, 2025

(54) METHOD AND SYSTEM FOR DATA-DRIVEN PREDICTION BASED ON SPATIAL INFORMATION CONSTRAINTS

(71) Applicant: University of Electronic Science and Technology of China, Yangtze River Delta Research Institute, Huzhou (CN)

(72) Inventors: Mei HE, Huzhou (CN); Tianji XU, Huzhou (CN); Pengpeng ZHI, Huzhou (CN); Guangwei ZHANG, Huzhou (CN); Jiao XUE, Huzhou (CN); Yu ZHONG, Huzhou (CN)

(21) Appl. No.: 18/384,049

(22) Filed: Oct. 26, 2023

(30) Foreign Application Priority Data
Sep. 20, 2023 (CN) 202311220090.0

(51) Int. Cl. G06N 3/084

(52) U.S. Cl. CPC G06N 3/084

(57) ABSTRACT

Provided herein is a method and a system for data-driven prediction based on spatial information constraints, belonging to the technical field of intelligent information processing. The method comprises: prediction target interpolation based on collocated Co-Kriging; sample weight calculation based on sequential Gaussian simulation and loss function construction based on spatial information constraints; optimization of loss function and data-driven prediction based on deep fully connected neural network. The system comprises: data acquisition module, data preprocessing module, prediction target interpolation module, sample weight calculation module, loss function construction module, loss function optimization module, data-driven prediction module. It realizes the expansion of learning samples under the restriction of spatial information, and uses the spatial information to optimize the loss function, thus improving the utilization rate of data information, facilitating guiding the learning process to converge to reasonable assumptions, thereby improving the performance of the prediction method based on data-driven.

### CROSS-REFERENCE TO RELATED APPLICATIONS

This is a U.S. patent application which claims the priority and benefit of Chinese Patent Application Number 202311220090.0, filed on Sep. 20, 2023, the disclosure of which is incorporated herein by reference in its entirety.

### TECHNICAL FIELD

The present disclosure belongs to the technical field of intelligent information processing, in particular to a method and a system for data-driven prediction based on spatial information constraints.

### BACKGROUND ART

Realizing the automation of data or information processing and interpretation with the help of artificial intelligence technology, and even embarking on exploratory research on the unknown from data, is a hot spot at present, and it is also an important driver of global digitalization process. However, the successful application of artificial intelligence technology represented by deep learning needs sufficient data samples, which makes many methods that perform well in the traditional intelligent computing field unable to show their contributions in the professional research field where data acquisition is expensive. In increasingly specialized fields, the cost of data acquisition rises, which leads to the scarcity and lack of representativeness of its learning sample data. Moreover, in many research fields, such as earth science, the geophysical observation data collected from the surface or from boreholes exhibit spatial characteristics, and the corresponding research objectives, whether the concrete underground rock distribution or the abstract reservoir parameter distribution, are distributed along a three-dimensional space. However, most of the existing methods are aimed at structured data, with insufficient consideration for the spatial correlation between data (points). For example, the deep fully connected neural network treats each sampling point in space as an isolated point that conforms to an unknown distribution but does not have spatial correlation. Although convolution neural network considers the spatial distribution of prediction purpose locally, it is mainly used for classification tasks, such as image recognition, image segmentation, etc. Moreover, the spatial correlation information used by convolution neural network is limited by the size of input samples, so it is difficult to consider the spatial correlation of learning samples globally. All these above restrict the popularization of intelligent learning methods to a certain extent.

Through the above analysis, the problems and defects of the prior art are as follows: the existing methods are mostly aimed at structured data, with insufficient consideration for the spatial correlation between data, which restricts the popularization of intelligent learning methods to a certain extent.

### SUMMARY

Aiming at the problems existing in the prior art, the present disclosure provides a method and a system for data-driven prediction based on spatial information constraints.

The present disclosure is realized as follows: a method for data-driven prediction based on spatial information constraints, which comprises:
S1: data acquisition and preprocessing;
S2: interpolation of a prediction target based on collocated Co-Kriging;
S3: calculation of sample weights based on sequential Gaussian simulation and construction of a loss function based on spatial information constraints; and
S4: optimization of the loss function and data-driven prediction based on deep fully connected neural network.

Further, the data acquisition and preprocessing in the S1 specifically comprises the following steps:
S11, aiming at the specific prediction target of the research object Y, various observation data X₁, X₂, L, Xₙ with different acquisition methods are obtained, and the collection form of each observation data is as follows:

$${X}_{i} = {\{ {x}_{i}^{( j )} \}}_{j = 1}^{{k}_{i}}$$

Wherein, x represents the samples in each data set, and kᵢ is the number of samples in the i data set;
S12, processing the outliers of median filling on the observation data {Xᵢ}ᵢ₌₁ⁿ; if the dimensions of each observation data are quite different, further normalization is performed, and the transformation formula is:

$${x}_{norm} = \frac{x - {x}_{min}}{{x}_{max} - {x}_{min}}$$

Where xₙₒᵣₘ represents the normalized sample, and xₘₐₓ and xₘᵢₙ are the maximum and minimum values of each observation data, respectively;
S13, applying a normal distribution transformation to the normalized X₁, X₂, L, Xₙ and Y to obtain [symbol] , L, [symbol] and [symbol] respectively.

Further, the interpolation of the prediction target based on collocated Co-Kriging in the S2 specifically comprises the following steps:
S21, respectively performing correlation analysis on [symbol] and [symbol] , L, [symbol] to determine [symbol] with the highest correlation with [symbol] ;
S22, taking [symbol] as the principal component Z₁ and [symbol] as the secondary variable Z₂, establishing an interpolation formula for Z₁:

$${Z}_{cok} ( {u}_{0} ) = {\sum }_{i = 1}^{n} {α}_{i} {Z}_{1} ( {u}_{i} ) + β {Z}_{2} ( {u}_{o} )$$

Where αᵢ and β are weighting coefficients and u is a spatial position vector, specifically, u₀ represents the position of the point to be estimated, {uᵢ}ᵢ₌₁ⁿ represents the position of the sampling point, n represents the number of sampling points, that is, the number of samples of Y, Z₁(uᵢ) represents the value of the principal component at uᵢ, and Z₂(u₀) represents the value of the secondary variable at u₀;
S23, based on the unbiased condition and the minimum variance condition, the following equations are obtained:

$$[ \begin{matrix}{C}^{1} ( 0 ) & {C}_{1 , 2}^{1} & L & {C}_{1 , n}^{1} & {C}_{1 , o}^{12} \\ {C}_{2 , 1}^{1} & {C}^{1} ( 0 ) & L & {C}_{2 , n}^{1} & {C}_{2 , o}^{12} \\ M & M & O & M & M \\ {C}_{n , 1}^{1} & {C}_{n , 2}^{1} & L & {C}^{1} ( 0 ) & {C}_{n , o}^{12} \\ {C}_{1 , o}^{12} & {C}_{2 , o}^{12} & L & {C}_{n , o}^{12} & {C}^{2} ( 0 )\end{matrix} ] [ \begin{matrix}{α}_{1} \\ {α}_{2} \\ M \\ {α}_{n} \\ β\end{matrix} ] = [ \begin{matrix}{C}_{1 , o}^{1} \\ {C}_{2 , o}^{1} \\ M \\ {C}_{n , o}^{1} \\ {C}^{12} ( 0 )\end{matrix} ]$$

where C¹, C² and C¹² represent the variance and covariance function of Z₁ and Z₂ respectively, specifically:

$${C}_{i , j}^{k} = Cov ( {Z}_{k} ( {u}_{i} ) , {Z}_{k} ( {u}_{j} ) ) , k = 1 , 2$$

$${C}_{i , o}^{12} = Cov ( {Z}_{1} ( {u}_{i} ) , {Z}_{2} ( {u}_{o} ) )$$

S24, calculating the experimental variogram of Z₁ and Z₂, and selecting an appropriate variogram model to fit them to obtain γ¹ and γ²; then the corresponding covariance functions C¹ and C² are obtained for γ¹ and γ², and the formula is:

$$γ ( h ) = C ( 0 ) - C ( h )$$

Where, h represents distance;
S25, constructing a cross-correlation function C¹² of Z₁ and Z₂, that is

$${C}^{12} ( h ) = {C}^{12} ( 0 ) \cdot \frac{{C}^{1} ( h )}{{C}^{1} ( 0 )}$$

S26, bringing the C¹, C² and C¹² into S23 to obtain the weighting coefficient in S22;
S27, interpolating the principal variable Z₁ based on S22; and
S28, based on the interpolated [symbol] (represented by Y′) and [symbol] , a point pair (x(u),y(u)) is established corresponding to the position u, where x(u)=[x₁(u), x₂(u), L, xₙ(u)]^{T} xᵢ(u)∈ [symbol] and y(u)∈Y′ the original learning samples D={(x(uᵢ), y(uᵢ))}ᵢ₌₁^{m} is obtained, and m=min(k₁,k₂,L,kₙ) is the number of samples.

Furthermore, the calculation of sample weights based on sequential Gaussian simulation and the construction of the loss function based on spatial information constraints in the S3 specifically comprises the following steps:
S31, dividing the space into grids, and defining a random path that passes through all unsampled positions only and only once;
S32, randomly walking on the grid in sequence according to the random path, and repeating the following steps for each access point along the random path:
(1) At each current access point u₀, calculating the Co-Kriging value y̅(u_{d}) of the point by using the parameter values x(uᵢ), i=1, 2,L,k and y(u₀) at a known point, wherein k represents the number of currently known sample points;
(2) Assigning the obtained y̅ to the corresponding position; and
(3) All the sampled data and simulated values are transformed by a normal inverse transformation;
S33, re-determine a random path and repeat the above steps until the difference between the realized mean value of each point and the obtained Z_{cok} in S22 is within an acceptable range;
S34, calculating the variance σ(u) based on multiple realizations on each grid point, and bring it into the standard normal distribution formula to obtain the probability density function of each point in space as follows:

$$f ( u ) = \frac{1}{\sqrt{2 π} σ ( u )}$$

this is taken as the weight ω(u) of y̅ interpolated in S22, that is

$$ω ( μ ) = \{ \begin{matrix}f ( μ ) , When μ is the sampling point position \\ 1 , When μ is the interpolation point position\end{matrix}$$

S35, establishing a loss function containing spatial information:

$$\begin{matrix}J ( θ ) = \frac{1}{2} ω ( {u}_{i} ) \cdot {\sum }_{i = 1}^{m} {‖ y ( {u}_{i} ) - \hat{y} ( {u}_{i} ) ‖}^{2} \\ = \frac{1}{2} ω ( {u}_{i} ) \cdot {\sum }_{i = 1}^{m} {( y ( {u}_{i} ) - {h}_{θ} ( x ( {u}_{i} ) ) )}^{2}\end{matrix}$$

where θ represents model parameters, y and ŷrepresent real values (including sampling point values and interpolation values) and predicted values, respectively, and h_{θ} represents deep fully connected neural network model.

Further, the optimization of the loss function and the data-driven prediction based on the deep fully connected neural network in the S4 specifically comprises the following steps:
S41, the samples at some sampling points are reserved to form a test set, and the remaining samples form a training set for training the deep fully connected neural network;
S42, optimizing the loss function by adopting a batch random gradient descent algorithm, and updating the parameters of the deep fully connected neural network; and
S43, the trained network model is used to predict the test set.

Another object of the present disclosure is to provide a system for data-driven prediction based on spatial information constraints of a method for data-driven prediction based on spatial information constraints, the system comprising:
a data acquisition module, which is used for acquiring various observation data with different acquisition modes aiming at the specific prediction target Y of the research object;
a data preprocessing module, which is connected with the data acquisition module and is used for processing the outliers of median filling on the observation data; if the dimensions of the observation data are quite different, they will be further normalized; if the sampling network layout of each observation data is very different, simple interpolation processing or Kriging interpolation is carried out for each observation data between outliers processing and normalization processing;
a prediction target interpolation module, which is connected with the data preprocessing module and is used for realizing the prediction target interpolation based on the collocated Co-Kriging;
a sample weight calculating module, which is connected with the prediction target interpolation module and is used for calculating the sample weight based on sequential Gaussian simulation;
a loss function construction module, which is connected with the sample weight calculating module and is used for constructing the loss function based on the spatial information constraints;
a loss function optimization module, which is connected with the loss function construction module and is used for optimizing the loss function by using a batch random gradient descent algorithm; and
a data-driven prediction module, which is connected with the loss function optimization module and is used for data-driven prediction based on the deep fully connected neural network.

A computer device includes a memory and a processor, the memory storing a computer program that, when executed by the processor, causes the processor to perform steps of the method for data-driven prediction based on spatial information constraints.

A computer-readable storage medium stores a computer program that, when executed by a processor, causes the processor to perform steps of the method for data-driven prediction based on spatial information constraints.

An information data processing terminal is used for realizing the system for data-driven prediction based on spatial information constraints.

Combined with the technical scheme and the technical problem solved, the technical scheme claimed by the present disclosure has the advantages and positive effects as follows:

Firstly, the present disclosure provides a method for data-driven prediction based on spatial information constraints. In this method, collocated Co-Kriging is used to interpolate the prediction target, so as to obtain a large number of pseudo-labels that conform to the spatial large-scale distribution law, which provides sufficient data guarantee for the method for data-driven prediction based on deep learning. Then, using multi-order Gaussian stochastic simulation, the normal distribution of the values at the positions of each pseudo-label is obtained, and the weights of each pseudo-label are obtained based on the distribution. Finally, the weight is added to the loss function of the deep fully connected neural network as a value to measure the reliability of each label, so that the learning process of the network is constrained by spatial information, which leads it to converge to a more reasonable hypothesis.

Secondly, the present disclosure realizes interpolation of prediction targets by means of correlation features with relatively dense spatial distribution, achieves the purpose of expanding learning samples under the constraint of spatial information, and provides data guarantee for deep learning technology.

The present disclosure adds the spatial information into the loss function of the depth fully connected neural network in the form of sample weights, and its function is similar to that of a regular term, which can constrain the learning process of the network to converge to more reasonable assumptions, thereby improving the applicability and prediction precision of the model.

Thirdly, the technical scheme of the present disclosure adopts the geostatistical method to expand the capacity of small sample data, which brings data guarantee to the depth learning method, and simultaneously uses the obtained spatial information to constrain the learning process of the depth fully connected neurons, which improves the data utilization rate and reasonably constrains the learning process of the intelligent method, which is helpful to ensure the rationality of the prediction solution.

The technical scheme of the present disclosure makes the data driving method represented by deep learning also applicable on small sample data, so that effective intelligent prediction based on small samples is realized, and the intelligent realization of professional research field is no longer restricted by small samples, thus promoting the intelligent process of professional field.

### BRIEF DESCRIPTION OF THE DRAWINGS

In order to explain the technical scheme of the embodiment of the present disclosure more clearly, the drawings needed to be used in the embodiment of the present disclosure will be briefly introduced below. Obviously, the drawings described below are only one or more embodiments of the present disclosure, and based on the drawings of the present disclosure, other drawings obtainable by a person skilled in the art without creative labor fall within the protection scope of the present disclosure.

FIG. 1 is a flowchart of a method for data-driven prediction based on spatial information constraints according to one or more embodiments of the present disclosure.

FIG. 2 is a schematic diagram of the specific implementation process according to one embodiment of the present disclosure;

FIG. 3 is a schematic diagram of observation data of according to one embodiment of the present disclosure, wherein part (a), part (b) and part (c) of FIG. 3 are seismic amplitude, phase and frequency attributes for predicting reservoir porosity, respectively;

FIG. 4 is a schematic diagram of an interpolation point weight calculation process according to one embodiment of the present disclosure; wherein, part (a) of FIG. 4 is a known target value; part (b) of FIG. 4 is a random point to be estimated; part (c) of FIG. 4 is the interpolation result of the point to be estimated; and part (d) of FIG. 4 is the weight estimation of the point to be estimated;

FIG. 5 is a schematic diagram of prediction target interpolation and sample weight calculation according to one embodiment of the present disclosure, wherein part (a) of FIG. 5 is a prediction target value after interpolation, and a white cross position indicates a sampling point; and part (b) of FIG. 5 shows the corresponding sample weights;

FIG. 6 is a schematic structural diagram of a deep fully connected neural network according to one embodiment of the present disclosure;

FIG. 7 is a comparison diagram of the loss curve of the deep fully connected neural network in the conventional method and the loss curve of the deep fully connected neural network in the proposed method of the present disclosure according to one embodiment of the present disclosure;

FIG. 8 is a comparison diagram between a prediction result and a real result according to one embodiment of the present disclosure, wherein part (a) of FIG. 8 is a prediction result obtained by a conventional prediction method; part (b) of FIG. 8 is a prediction result obtained by the method proposed by the present disclosure; and part (c) of FIG. 8 shows the real spatial distribution of reservoir porosity; and

FIG. 9 is a structural diagram of a system for data-driven prediction based on spatial information constraints according to one or more embodiments of the present disclosure.

### DETAILED DESCRIPTION

In order to make the object, technical scheme and advantages of the present disclosure more clear, the present disclosure is described in further detail below in connection with the embodiments. It should be understood that the specific embodiments described herein are intended to explain the present disclosure only and are not intended to be a limit of the present disclosure.

Aiming at the problems existing in the prior art, the present disclosure provides a method and a system for data-driven prediction based on spatial information constraints.

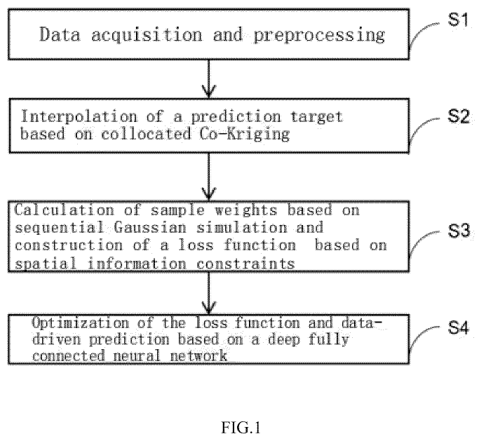

As shown in FIG. 1, the embodiment of the present disclosure provides a method for data-driven prediction based on spatial information constraints, which comprises:
S1: data acquisition and preprocessing;
S2: interpolation of a prediction target based on collocated Co-Kriging;
S3: calculation of sample weights based on sequential Gaussian simulation and construction of a loss function based on spatial information constraints; and
S4: optimization of the loss function and data-driven prediction based on deep fully connected neural network.

According to one or more embodiments, the data acquisition and preprocessing specifically comprises the following steps:
S11, aiming at the specific prediction target of the research object Y, various observation data X₁, X₂, L, Xₙ with different acquisition methods are obtained, and the collection form of each observation data is as follows:

$${X}_{i} = {\{ {x}_{i}^{( j )} \}}_{j = 1}^{{k}_{i}}$$

Wherein, x represents the samples in each data set, and kᵢ is the number of samples in the i data set;
S12, processing the outliers of median filling on the observation data {Xᵢ}ᵢ₌₁ⁿ; if the dimensions of each observation data are quite different, further normalization is performed, and the transformation formula is:

$${x}_{norm} = \frac{x - {x}_{min}}{{x}_{max} - {x}_{min}}$$

Where xₙₒᵣₘ represents the normalized sample, xₘₐₓ and xₘᵢₙ are the maximum and minimum values of each observation data, respectively;
S13, applying a normal distribution transformation to the normalized X₁, X₂, L, Xₙ and Y to obtain [symbol] , L, [symbol] and [symbol] respectively.

It should be noted that because of the different acquisition methods, the precision and error sources of each observation data are also different, so the preprocessing methods of each observation data also include noise reduction processing suitable for the features of the data.

According to one or more embodiments, the interpolation of the prediction target based on the collocated Co-Kriging specifically comprises the following steps:
S21, respectively performing correlation analysis on [symbol] and [symbol] , L, [symbol] to [symbol] with the highest correlation with [symbol] ;
S22, taking [symbol] as the principal component Z₁ and [symbol] as the secondary variable Z₂, establishing an interpolation formula for Z₁:

$${Z}_{cok} ( {u}_{0} ) = {\sum }_{i = 1}^{n} {α}_{i} {Z}_{1} ( {u}_{i} ) + β {Z}_{2} ( {u}_{o} )$$

Where αᵢ and β are weighting coefficients and u is a spatial position vector, specifically, u₀ represents the position of the point to be estimated, {uᵢ}ᵢ₌₁ⁿ represents the position of the sampling point n represents the number of sampling points, that is, the number of samples of Y; Z₁(uᵢ) represents the value of the principal component at uᵢ, and Z₂(u₀) represents the value of the secondary variable at u₀;
S23, based on the unbiased condition and the minimum variance condition, the following equations are obtained:

$$[ \begin{matrix}{C}^{1} ( 0 ) & {C}_{1 , 2}^{1} & L & {C}_{1 , n}^{1} & {C}_{1 , o}^{12} \\ {C}_{2 , 1}^{1} & {C}^{1} ( 0 ) & L & {C}_{2 , n}^{1} & {C}_{2 , o}^{12} \\ M & M & O & M & M \\ {C}_{n , 1}^{1} & {C}_{n , 2}^{1} & L & {C}^{1} ( 0 ) & {C}_{n , o}^{12} \\ {C}_{1 , o}^{12} & {C}_{2 , o}^{12} & L & {C}_{n , o}^{12} & {C}^{2} ( 0 )\end{matrix} ] [ \begin{matrix}{α}_{1} \\ {α}_{2} \\ M \\ {α}_{n} \\ β\end{matrix} ] = [ \begin{matrix}{C}_{1 , o}^{1} \\ {C}_{2 , o}^{1} \\ M \\ {C}_{n , o}^{1} \\ {C}^{12} ( 0 )\end{matrix} ]$$

where C¹, C² and C¹² represent the variance and covariance function of Z₁ and Z₂ respectively, specifically:

$${C}_{i , j}^{k} = Cov ( {Z}_{k} ( {u}_{i} ) , {Z}_{k} ( {u}_{j} ) ) , k = 1 , 2$$

$${C}_{i , o}^{12} = Cov ( {Z}_{1} ( {u}_{i} ) , {Z}_{2} ( {u}_{o} ) )$$

S24, calculating the experimental variogram of Z₁ and Z₂, and selecting an appropriate variogram model to fit them to obtain γ¹ and γ²; then the corresponding covariance functions C¹ and C² are obtained for γ¹ and γ², and the formula is:

$$γ ( h ) = C ( 0 ) - C ( h )$$

where, h represents distances;
S25, constructing a cross-correlation function C¹² of Z₁ and Z₂, namely

$${C}^{12} ( h ) = {C}^{12} ( 0 ) \cdot \frac{{C}^{1} ( h )}{{C}^{1} ( 0 )}$$

S26, bringing the C¹, C² and C¹² into S23 to obtain the weighting coefficient in S22;
S27, interpolating the principal variable Z₁ based on S22;
S28, based on the interpolated [symbol] (represented by Y′) and [symbol] , a point pair (x(u),y(u)) is established corresponding to the position u, where x(u)=[x₁(u),x₂(u),L,xₙ(u)]^{T} xᵢ(u)∈ [symbol] and y(u)∈Y′, the original learning samples D={(x(uᵢ),y(uᵢ))}ᵢ₌₁^{m} is obtained, and m=min(k₁,k₂,L,kₙ) is the number of samples.

It should be noted that if the sampling point position of each observation data is deviated, simple interpolation processing or Kriging interpolation can be carried out on each observation data, provided that the spatial distribution density of the observation data used for constructing the feature vector is far greater than the prediction target.

According to one or more embodiments, the sample weight calculation based on sequential Gaussian simulation and the construction of loss function based on spatial information constraints specifically comprises the following steps:
S31, dividing the space into grids, and defining a random path that passes through all unsampled positions only and only once;
S32, randomly walking on the grid in sequence according to the random path, and repeating the following steps for each access point along the random path:
(1) a each current access point u₀, calculating the Co-Kriging value y̅(u₀) of the point by using the parameter values x(uᵢ), i=1, 2, L, k and y(u₀) at the known point, wherein k represents the number of currently known sample points;
(2) assigning the obtained y̅ to the corresponding position; and
(3) all the sampled data and simulated values are transformed by normal inverse transformation; and
S33, re-determine a random path and repeat the above steps until the difference between the realized mean value of each point and the obtained Z_{cok} in S22 is within an acceptable range;

It should be noted that when the number of sequential Gaussian stochastic simulation approaches infinity, the mean value of all simulation results will approach Kriging estimation. However, in practical application, excessive simulation times will bring great operational costs, so the number of random simulations or termination conditions must be given reasonably.
S34, calculating the variance σ(u) based on multiple realizations on each grid point, and bring it into the standard normal distribution formula to obtain the probability density function of each point in space as follows:

$$f ( u ) = \frac{1}{\sqrt{2 π} σ ( u )}$$

this is taken as the weight ω(u) of y obtained by interpolation in S22, that is

$$ω ( μ ) = \{ \begin{matrix}f ( μ ) , When μ is the sampling point position \\ 1 , When μ is the interpolation point position\end{matrix}$$

S35, establishing a loss function containing spatial information:

$$\begin{matrix}J ( θ ) = \frac{1}{2} ω ( {u}_{i} ) \cdot {\sum }_{i = 1}^{m} {‖ y ( {u}_{i} ) - \hat{y} ( {u}_{i} ) ‖}^{2} \\ = \frac{1}{2} ω ( {u}_{i} ) \cdot {\sum }_{i = 1}^{m} {( y ( {u}_{i} ) - {h}_{θ} ( x ( {u}_{i} ) ) )}^{2}\end{matrix}$$

Where θ represents model parameters, y and ŷ represent real values (including sampling point values and interpolation values) and predicted values, respectively, and h^{θ} represents deep fully connected neural network model.

According to one or more embodiments, the optimization of the loss function and the data-driven prediction based on the deep fully connected neural network specifically comprise the following steps:
S41, the samples at some sampling points are reserved to form a test set, and the remaining samples form a training set for training the deep fully connected neural network;
S42, optimizing the loss function by adopting a batch random gradient descent algorithm, and updating the parameters of the deep fully connected neural network; and
S43, the trained network model is used to predict the test set.

It should be noted that the activation function in the deep fully connected neural network is selected as ReLU; In order to improve the generalization of the model, Dropout regularization is carried out for each fully connected layer, and the regularization coefficient is 0.1; In addition, in order to prevent over-fitting of the model, ⅓ of the training data is used as verification data in the model learning process, which is used for implementing the early stop mechanism, and the network training is stopped when the loss value on the verification data does not decrease after 10 iterations.

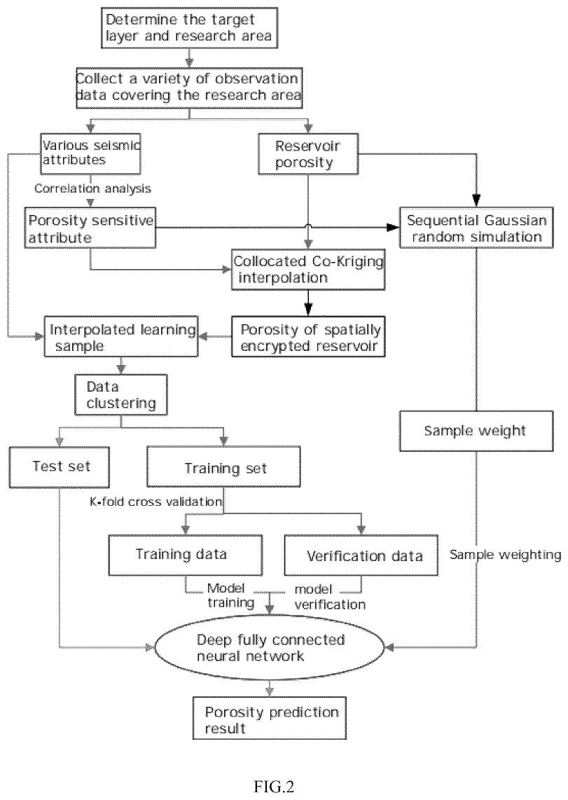

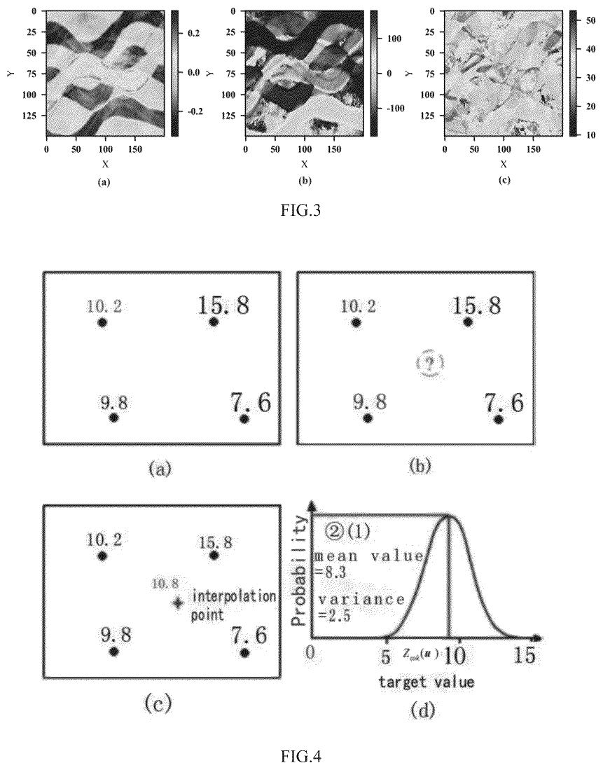

In this embodiment, FIG. 2 is a specific implementation flow of the method for data-driven prediction based on spatial information constraints proposed by the present disclosure in reservoir porosity prediction. The data used in this embodiment is Stanford VI model data, and the prediction target is the porosity distribution of a certain target layer. The inputs are three types of seismic attributes, extracted from the seismic data obtained by forward modeling, as shown in FIG. 3, where (a), (b) and (c) of FIG. 3 are the amplitude, frequency and phase attributes respectively.

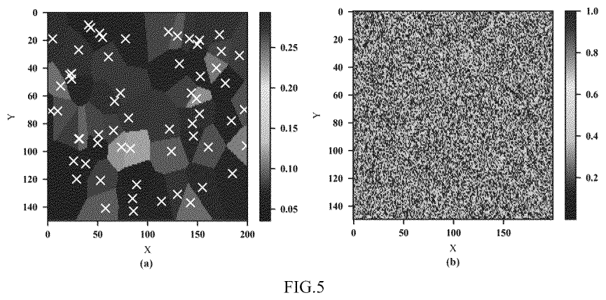

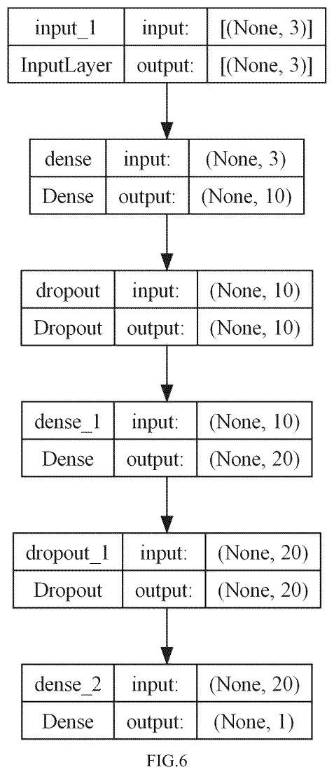

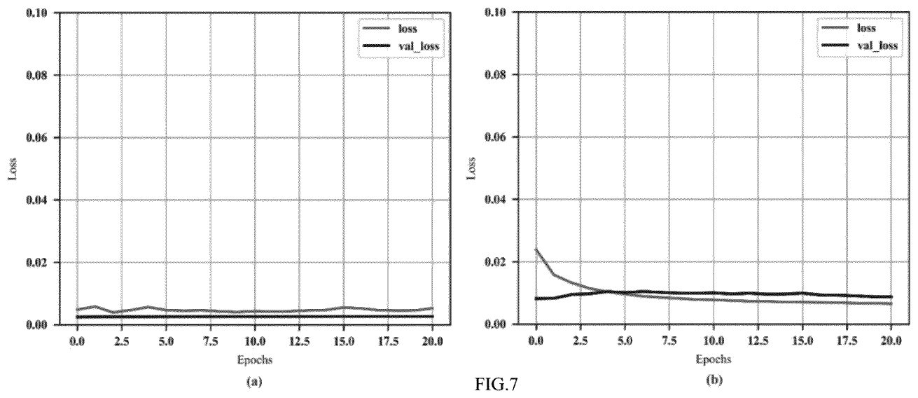

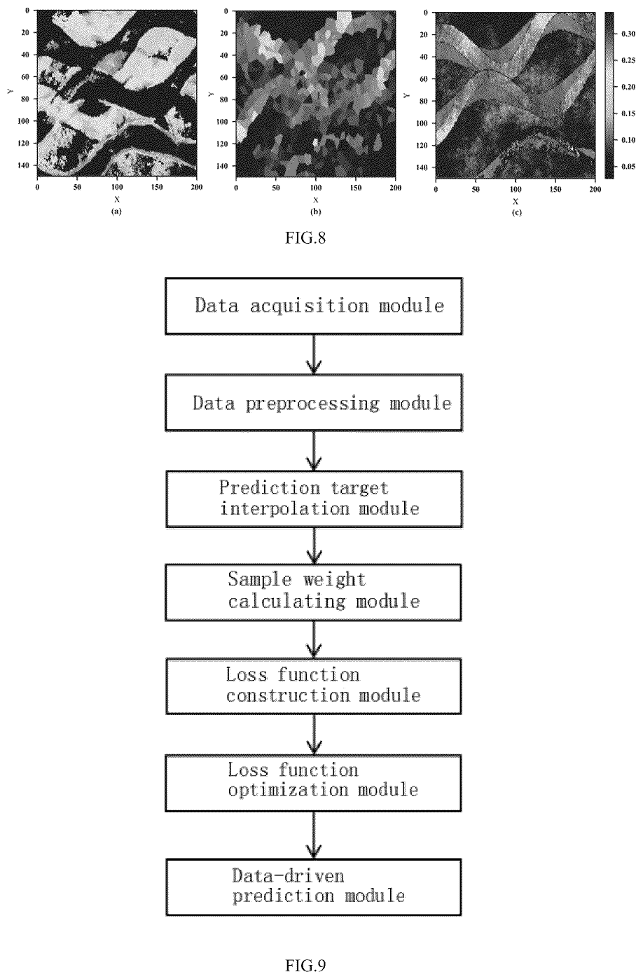

In this embodiment, when the number of wells is 70, as shown in FIG. 4, the process of calculating the weight of interpolation samples under the constraint of spatial information for the method proposed in the present disclosure is tested. FIG. 5 shows the spatial distribution of porosity after interpolation (part (a) of FIG. 5) and the corresponding weights (part (b) of FIG. 5) calculated based on the process shown in FIG. 4. Due to the limited number of samples, this embodiment establishes a small deep fully connected neural network as shown in FIG. 6. As shown in part (a) of FIG. 7, the learning situation of the conventional driving prediction method based on the deep fully connected neural network shows that the learning effect of the deep fully connected neural network based on small samples is very unsatisfactory, the loss curve does not show obvious fluctuation due to insufficient samples, and the updating of network parameters is extremely limited. Part (b) of FIG. 7 is a schematic diagram of the loss curve of the method proposed by the present disclosure, which is smoother and has learning performance compared with part (a) of FIG. 7.

As shown in FIG. 8, the present disclosure compares the prediction result of the real spatial distribution of the research target with its real spatial distribution, wherein part (a), part (b) and part (c) of FIG. 8 are respectively the prediction result of the conventional method for data-driven prediction based on the depth fully connected neural network, the prediction result obtained based on the method proposed by the present disclosure and the actual spatial distribution of reservoir porosity. It can be seen from the figure that the traditional data-driven method based on the deep fully connected network cannot effectively capture the porosity information contained in the small sample data, whereas, although the prediction of the boundary of the river channel indicated by the high porosity area is insufficient, the method proposed by the present disclosure realizes a good capture of the overall spatial distribution thereof.

Another object of the present disclosure is to provide a system for data-driven prediction based on spatial information constraints of a method for data-driven prediction based on spatial information constraints, the system comprising:
a data acquisition module, which is used for acquiring various observation data with different acquisition modes aiming at the specific prediction target of the research object;
a data preprocessing module, which is connected with the data acquisition module and is used for processing the outliers of median filling on the observation data; if the dimensions of the observation data are quite different, they will be further normalized; if the sampling network layout of each observation data is very different, simple interpolation processing or Kriging interpolation is carried out for each observation data between outliers processing and normalization processing;
a prediction target interpolation module, which is connected with the data preprocessing module and is used for realizing the prediction target interpolation based on the collocated Co-Kriging;
a sample weight calculating module, which is connected with the prediction target interpolation module and is used for calculating the sample weight based on sequential Gaussian simulation;
a loss function construction module, which is connected with the sample weight calculating module and is used for construct the loss function based on the spatial information constraints;
a loss function optimization module, which is connected with the loss function construction module and is used for optimizing the loss function by using a batch random gradient descent algorithm; and
a data-driven prediction module, which is connected with the loss function optimization module and is used for data-driven prediction based on the deep fully connected neural network.

A computer device includes a memory and a processor, the memory storing a computer program that, when executed by the processor, causes the processor to perform steps of the method for data-driven prediction based on spatial information constraints.

A computer-readable storage medium stores a computer program that, when executed by a processor, causes the processor to perform steps of the method for data-driven prediction based on spatial information constraints.

An information data processing terminal is used for realizing the system for data-driven prediction based on spatial information constraints.

### Embodiment 1: Prediction of Urban Air Quality

### S1: Data Acquisition and Preprocessing

Collecting PM2.5, PM10, SO2 and other data from multiple monitoring stations.

Data cleaning to remove missing values and outliers.

### S2: Interpolation of a Prediction Target Based on Collocated Co-Kriging

Collocated Co-Kriging method is used to interpolate and predict the data between different monitoring stations.

### S3: Calculation of Sample Weights Based on Sequential Gaussian Simulation and Construction of a Loss Function Based on Spatial Information Constraint

Sequential Gaussian simulation is applied to calculate the sample weight of each monitoring station.

Constructing the loss function with spatial information.

### S4: Optimization of Loss Function and Data-Driven Prediction Based on a Deep Fully Connected Neural Network

Optimization algorithms such as SGD are used to optimize the loss function.

Based on the optimization results, the deep fully connected neural network is used for prediction.

### Embodiment 2: Prediction of Agricultural Yield

### S1: Data Acquisition and Preprocessing

Collect soil moisture, air temperature, light and other parameters of each farmland.

Data preprocessing, standardization and normalization.

### S2: Interpolation of a Prediction Target Based on Collocated Co-Kriging

Collocated Co-Kriging method is used to interpolate the data of each point in farmland.

### S3: Calculation of Sample Weights Based on Sequential Gaussian Simulation and Construction of a Loss Function Based on Spatial Information Constraint

Sequential Gaussian simulation is used to calculate the sample weight of each farmland point.

The loss function is constructed by using the spatial information of each farmland point.

### S4: Optimization of Loss Function and Data-Driven Prediction Based on Deep Fully Connected Neural Network

Optimization algorithms including but not limited to SGD and Adam are applied to optimize the loss function.

Using the deep fully connected neural network to predict crop yield.

These two embodiments cover different application scenarios and demonstrate the diversity and universality of the method. In the implementation process, the specific algorithms and parameters need to be adjusted according to the actual needs.

It should be noted that embodiments of the present disclosure may be implemented by hardware software or a combination of software and hardware. The hardware part can be realized by dedicated logic. The software portion may be stored in memory and executed by a suitable instruction execution system such as a microprocessor or custom-designed hardware. Those skilled in the art can understand that the above-mentioned devices and methods can be implemented using computer-executable instructions and/or contained in processor control code, for example, such code is provided on a carrier medium such as a magnetic disk, a CD or DVD-ROM, a programmable memory such as a read-only memory (firmware) or a data carrier such as an optical or electronic signal carrier. The device and its modules of the present disclosure can be realized by hardware circuits such as very large scale integrated circuits or gate arrays, semiconductors such as logic chips and transistors, or programmable hardware devices such as field programmable gate arrays and programmable logic devices, or by software executed by various types of processors, or by a combination of the above hardware circuits and software such as firmware.

The above are only the specific implementations of the present disclosure, but the protection scope of the present disclosure is not limited to this. Any modification, equivalent substitution and improvement made within the spirit and principle of the present by those skilled in the art according to the disclosed technical scope should be included in the protection scope of the present disclosure.

What is claimed is:

1. A method for data-driven prediction based on spatial information constraints, comprising:
S1: data acquisition and preprocessing;
S2: interpolation of a prediction target based on collocated Co-Kriging;
S3: calculation of sample weights based on sequential Gaussian simulation and construction of a loss function based on spatial information constraints; and
S4: optimization of the loss function and data-driven prediction based on a deep fully connected neural network.

2. The method for data-driven prediction based on spatial information constraints according to claim 1, wherein, the data acquisition and preprocessing in the S1 comprises the following steps:
S11, aiming at the specific prediction target of the research object Y, various observation data X₁, X₂, L, X, with different acquisition methods are obtained, and the collection form of each observation data is as follows:
$${X}_{i} = {\{ {x}_{i}^{( j )} \}}_{j = 1}^{{k}_{i}}$$
wherein, x represents the samples in each data set, and kᵢ is the number of samples in the i data set;
S12, processing outliers of median filling on the observation data {Xᵢ}ᵢ₌₁ⁿ; if the dimensions of each observation data are quite different, further normalization is performed, and the transformation formula is:
$${x}_{norm} = \frac{x - {x}_{min}}{{x}_{max} - {x}_{min}}$$
where xₙₒᵣₘ represents the normalized sample, xₘₐₓ and xₘᵢₙ are the maximum and minimum values of each observation data, respectively; and
S13, applying a normal distribution transformation to the normalized X₁, X₂, L, Xₙ and Y to obtain [symbol] , L, [symbol] and [symbol] respectively.

3. The method for data-driven prediction based on spatial information constraints according to claim 1, wherein, the interpolation of a prediction target based on collocated Co-Kriging in the S2 comprises the following steps:
S21, respectively performing correlation analysis on [symbol] and [symbol] , L, [symbol] to determine [symbol] with the highest correlation with [symbol] ;
S22, taking [symbol] as the principal component Z₁ and [symbol] as the secondary variable Z₂, establishing an interpolation formula for Z₁:
$${Z}_{cok} ( {u}_{o} ) = {\sum }_{i = 1}^{n} {α}_{i} {Z}_{1} ( {u}_{i} ) + β {Z}_{2} ( {u}_{o} )$$
where αᵢ and β are weighting coefficients and u is a spatial position vector, specifically, u₀ represents the position of the point to be estimated, {uᵢ}ᵢ₌₁ⁿ represents the position of the sampling point, n represents the number of sampling points, that is, the number of samples of Y; Z₁(uᵢ) represents the value of the principal component at uᵢ, and Z₂(u₀) represents the value of the secondary variable at u₀;
S23, based on the unbiased condition and the minimum variance condition, the following equations are obtained:
$$[ \begin{matrix}{C}^{1} ( 0 ) & {C}_{1 , 2}^{1} & L & {C}_{1 , n}^{1} & {C}_{1 , o}^{12} \\ {C}_{2 , 1}^{1} & {C}^{1} ( 0 ) & L & {C}_{2 , n}^{1} & {C}_{2 , o}^{12} \\ M & M & O & M & M \\ {C}_{n , 1}^{1} & {C}_{n , 2}^{1} & L & {C}^{1} ( 0 ) & {C}_{n , o}^{12} \\ {C}_{1 , o}^{12} & {C}_{2 , o}^{12} & L & {C}_{n , o}^{12} & {C}^{2} ( 0 )\end{matrix} ] [ \begin{matrix}{α}_{1} \\ {α}_{2} \\ M \\ {α}_{n} \\ β\end{matrix} ] = [ \begin{matrix}{C}_{1 , o}^{1} \\ {C}_{2 , o}^{1} \\ M \\ {C}_{n , o}^{1} \\ {C}^{12} ( 0 )\end{matrix} ]$$
where C¹, C² and C¹² represent the variance and covariance function of Z₁ and Z₂ respectively, specifically:
$${C}_{i , j}^{k} = Cov ( {Z}_{k} ( {u}_{i} ) , {Z}_{k} ( {u}_{j} ) ) , k = 1 , 2$$
$${C}_{i , o}^{12} = Cov ( {Z}_{1} ( {u}_{1} ) , {Z}_{2} ( {u}_{o} ) )$$
S24, calculating the experimental variogram of Z₁ and Z₂, and selecting an appropriate variogram model to fit them to obtain γ¹ and γ²; then the corresponding covariance functions C¹ and C² are obtained for γ¹ and γ², and the formula is:
$$γ ( h ) = C ( 0 ) - C ( h )$$
where, h represents distances;
S25, constructing a cross-correlation function C¹² of Z₁ and Z₂, that is
$${C}^{12} ( h ) = {C}^{12} ( 0 ) \cdot \frac{{C}^{1} ( h )}{{C}^{1} ( 0 )}$$
S26, bringing the C¹, C² and C¹² into S23 to obtain the weighting coefficient in S22;
S27, interpolating the principal variable Z₁ based on S22; and
S28, based on the interpolated [symbol] (represented by Y′) and [symbol] , a point pair (x(u), y(u)) is established corresponding to the position a, where x(u)=[x₁(u),x₂(u),L,xₙ(u)]^{T} xᵢ(u)∈ [symbol] and y(u)∈Y′, the original learning samples D={(x(uᵢ),y(uᵢ))}ᵢ₌₁^{m} is obtained, and m=min(k₁,k₂,L,kₙ) is the number of samples.

4. The method for data-driven prediction based on spatial information constraints according to claim 1, wherein, the calculation of sample weights based on sequential Gaussian simulation and the construction of the loss function based on spatial information constraint in the S3 comprise the following steps:
S31, dividing the space into grids, and defining a random path that passes through all unsampled positions only and only once;
S32, randomly walking on the grid in sequence according to the random path, and repeating the following steps for each access point along the random path:
(1) at each current access point u₀, calculating the Co-Kriging value y̅(u₀) of the point by using the parameter values x(uᵢ), i=1, 2,L,k and y(u₀) at a known point, wherein k represents the number of currently known sample points;
(2) assigning the obtained y̅ to the corresponding position; and
(3) all the sampled data and simulated values are transformed by normal inverse transformation;
S33, re-determine a random path and repeat the above steps until the difference between the realized mean value of each point and the obtained Z_{cok} in S22 is within an acceptable range;
S34, calculating the variance σ(u) based on multiple realizations on each grid point, and bring it into the standard normal distribution formula to obtain the probability density function of each point in space as follows:
$$f ( u ) = \frac{1}{\sqrt{2 π} σ ( u )}$$
which is taken as the weight ω(u) of y̅ obtained by interpolation in S22, that is
$$ω ( μ ) = \{ \begin{matrix}f ( μ ) , When μ is the sampling point position \\ 1 , When μ is the interpolation point position\end{matrix}$$
S35, establishing a loss function containing spatial information:
$$\begin{matrix}J ( θ ) = \frac{1}{2} ω ( {u}_{i} ) \cdot {\sum }_{i = 1}^{m} {‖ y ( {u}_{i} ) - \hat{y} ( {u}_{i} ) ‖}^{2} \\ = \frac{1}{2} ω ( {u}_{i} ) \cdot {\sum }_{i = 1}^{m} {( y ( {u}_{i} ) - {h}_{θ} ( x ( {u}_{i} ) ) )}^{2}\end{matrix}$$
Where θ represents model parameters, y and ŷ represent real values and predicted values, respectively, and h_{θ} represents a deep fully connected neural network model, wherein the real values includes sampling point values and interpolation values.

5. The method for data-driven prediction based on spatial information constraints according to claim 1, wherein, the optimization of the loss function and the data-driven prediction based on the deep fully connected neural network in the S4 comprise the following steps:
S41, the samples at some sampling points are reserved to form a test set, and the remaining samples form a training set for training the deep fully connected neural network;
S42, optimizing the loss function by adopting a batch random gradient descent algorithm, and updating the parameters of the deep fully connected neural network; and
S43, the trained network model is used to predict the test set.

6. A system for data-driven prediction based on spatial information constraints according to the method for data-driven prediction based on spatial information constraints according to claim 1, which comprises:
a data acquisition module, which is used for acquiring various observation data with different acquisition modes aiming at the specific prediction target of the research object;
a data preprocessing module, which is connected with the data acquisition module and is used for processing the abnormal value of median filling on the observation data; if the dimensions of the observed data are quite different, they will be further normalized;
a prediction target interpolation module, which is connected with the data preprocessing module and is used for realizing the prediction target interpolation based on the collocated Co-Kriging;
a sample weight calculating module, which is connected with the prediction target interpolation module and is used for calculating the sample weight based on sequential Gaussian simulation;
a loss function construction module, which is connected with the sample weight calculating module and is used for constructing the loss function based on the spatial information constraint;
a loss function optimization module, which is connected with the loss function construction module and is used for optimizing the loss function by using a batch random gradient descent algorithm; and
a data-driven prediction module, which is connected with the loss function optimization module and is used for data-driven prediction based on the deep fully connected neural network.

7. A computer device which comprising a memory and a processor, the memory storing a computer program that, when executed by the processor, causes the processor to perform the steps of the method for data-driven prediction based on spatial information constraints according to claim 1.

8. A computer-readable storage medium storing a computer program that, when executed by the processor, causes the processor to perform the steps of the method for data-driven prediction based on spatial information constraints according to claim 1.

9. An information data processing terminal, which is used for implementing the system for data-driven prediction based on spatial information constraints according to claim 6.
